(19) United States
(12) Patent Application Publication
(10) Pub. No.: US 2012/0047054 A1
(43) Pub. Date: Feb. 23, 2012

(54) METHOD, SYSTEM, COMPUTER PROGRAM PRODUCT AND MARKETPLACE FOR PRIVATE AND PUBLIC INVESTMENT

(75) Inventor: Michael VASINKEVICH, New York, NY (US)

(73) Assignee: Michael VasinKevich, New York, NY (US)

(21) Appl. No.: 12/861,450

(22) Filed: Aug. 23, 2010

(51) Int. Cl. G06Q 40/00

(52) U.S. Cl. 705/35

(57) ABSTRACT

A method, system, computer program product and financial marketplace for placing private and public investment that includes matching investment projects and investors over a communications network and functions as a marketplace for matching sellers of investments (e.g., securities) with investors. The market may be automated or function with human assistance over a communications network that permits instantaneous communication between participants. Walls of confidentiality between parties allow investors matched with a seller to obtain a preliminary look at the investment project prior to signing a non-disclosure agreement. A collaboration tool that includes a clearing house and/or market environment that functions as a virtual marketplace for investment products (securities) such as private non-registered investments and registered investments.

### BACKGROUND OF THE INVENTION

1. Field of the Invention

The invention includes a method, system, computer program product and financial marketplace for placing private and public investment. The invention includes matching investment projects and investors over a communications network. Investors and investment projects are matched in stages to preserve any of the privacy, anonymity or confidentiality of any of the parties. The invention includes stages and/or phases of automation whereby investment projects and investors are at least partially matched and/or transactions are at least partially carried out automatically by computer.

2. Discussion of the Related Art

Private investment is an important component of the economic growth and vitality of developed nations. Such investments are generally not open to participation to the public and thus are described as private. Private investment includes projects and agreements between two or more parties in which a first party (e.g., an investment project) seeks an investment in the form of capital. The first party may approach one or more second parties (e.g., investors) with requests for investment. Alternately, one or more investors may approach an investment project with an offer of investment in exchange for a financial interest in the investment project. The financial interest may be in the form of, for example, an ownership stake in the form of shares of equity, or a guaranteed and/or variable rate of return based on predetermined agreements and/or targets.

Investment projects and investors have traditionally found one another using methods that include the services of a third party intermediary. A third party intermediary that brings together investors and investment projects may be an individual, group or corporation having a well-established network of contacts of proven or potential investors. Such networks are often represented by institutions, companies and/or investment organizations such as investment bankers. The relationships between investors and third party intermediaries may span many years and/or generations.

The services of a third party intermediary may add substantial transaction costs to one or both of the investment project or the investor involved in an transaction (e.g., an agreement by which funds are placed with an investment project). Transaction costs may include finder's fees, commissions, subscriptions and the like. For example, an investment project in need of capital may approach a third party intermediary with a request for capital. The third party intermediary, upon consideration of the investment project's details, may recommend or demand changes such that potential investors are presented with a higher rate of return.

Transaction costs may also be manifested in restrictions, covenants or modifications of an investment project's goals or products. A third party intermediary may require that any agreement between investment project and investor include such contractual agreements for the benefit of the investor.

Investors are often separated geographically, politically and/or economically from investment projects. This lack of familiarity between investment project and investor may give a third party intermediary a stronger negotiating position with respect to the particulars of an investment project. For example, a third party intermediary may become aware of a financial project that is in distress or badly in need of a capital infusion or refinancing. The third party intermediary may approach a first group of investors offering a particular rate of return, for example, in the form of senior or subordinate notes or shares of equity, e.g., in a first tranche. The first group of investors may represent a favored group of investors having a long-standing relationship with the third party intermediary and may be given preferential access to certain investment projects over a second group of investors who, although of equal financial stature, are less sophisticated or have a lower ranking relationship with the third party mediator. In this manner the second group of investors may be offered access only to less senior and/or less favored portions of the investment project thus resulting in increased transaction costs in the form of a relatively lower rate of return and/or a relatively higher degree of risk in comparison to the first group of investors.

Private investment is often the only source of funding and/or capital for illiquid or unconventional investment projects. Illiquid investments may include both physical assets (e.g., in the form of distressed real estate) and securities such as junk bonds and/or equity in companies faced with a high risk of foreclosure or bankruptcy. Private investment is, however, often the preferred source of funds for companies that are not publically traded and who wish to protect the confidentiality of their investment projects.

Private investment is also often used for illiquid securities and other financial assets such as liens, receivables, intellectual property, equity, debt, and the like. Such illiquid investments and/or financial assets are rarely offered publicly for the reason that they may not comply with applicable regulatory standards and/or the costs and delay of seeking regulatory approval may be greater than the expected rate of return.

Not only may private investment projects be burdened with the transaction costs associated with third party intermediaries, in some cases it is necessary to draft particular legal agreements between the parties representing investment project and investors, respectively. The time and resources needed to prepare legal documents such as non-disclosure agreements and contracts may further depress the desirability and/or marketability of an investment project. Especially in the case of investment projects which involve illiquid or unconventional assets, the costs of preparing the legal particulars can substantially raise the transaction costs of an investment project.

Further, both the investment project and the investors may have proprietary information and/or business processes which they do not wish to share with the public. This complication often restricts investment projects from advertising for investors. In a public transaction a competing investment project could obtain proprietary information on an investment project's business plans by posing as a potential investor and subsequently using the information to the competitor's advantage. This desire for confidentiality and privacy further complicates matching of investment project and investors.

The present invention provides a method, system, marketplace and computer program product for matching investment projects and investors to reduce transaction costs, maintain privacy and confidentiality, and automate investment transactions.

### SUMMARY OF THE INVENTION

It is an object of the invention to provide a method, system, financial marketplace and computer program product for placing private investment projects with investors.

It is a further object of the invention to provide a method, system, marketplace and computer program product for placing illiquid and/or unconventional investments and securities with investors.

It is a further object of the invention to place private investment projects and/or illiquid investments with investors with low transaction costs.

It is a further object of the invention to match investment projects with investors using an automated method, system, financial product and/or computer program product that automates one or more steps of identifying, matching and developing agreement between investment projects and investors.

It is a further object of the invention to provide a collaboration tool that includes a clearing house and/or market community that functions as a virtual marketplace for investment projects and securities.

It is a further object of the invention to provide a virtual marketplace in which an operator matches sellers of investments such as securities with investors using automation or human assistance.

It is a further embodiment of the invention to use a communications network in which a pool of investors that is pre-selected and/or vetted, is matched with or compared against a pool of investment projects.

It is a further object of the invention to use an electronic trading platform over a communications network to place investment projects with investors.

It is a further embodiment of the invention to use a communications network including one or more electronic information sources provided by a mediator or third party to aid in the placement of investment projects with investors.

It is a further object of the invention to match investment projects and investors in an automated manner without giving access to proprietary or private information to either or both of the investment project or investor.

It is a further object of the invention to provide and utilize a communications network for private and confidential communication an intermediary in contact with investors and corresponding investment projects.

It is a further object of the invention to place investment projects with investors such that investors and investment projects may obtain a preliminary analysis or information request from the other party without submitting private or proprietary information.

In a further object of the invention an operator maintains and manages walls of confidentiality between parties such that an investors matched with an investment project obtains preliminary review of an investment project prior to signing a non-disclosure agreement.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a depiction of one aspect of the invention in which a mediator operates in a communications network connecting one or more investment projects with one or more investors to consummate a deal in which cash is exchanged for an investment interest;

FIG. 2 depicts an embodiment of the invention in which a query is dispatched from a mediator to one or more investors;

FIG. 3 shows a diagram of an aspect of the communications environment which may be used to implement one or more aspects of the invention.

### DETAILED DESCRIPTION OF THE INVENTION

Unless otherwise stated herein, the terms used to describe and claim the invention take those definitions described in the “Dictionary of Business Terms,” 3^{rd} ed., J. P. Friedman, published by Barron's Business Guides (2000).

Assets and securities that may be bought, sold and exchanged in the invention include, without limitation, both registered and non-registered investments. Investment projects include both equity and debt securities. Equities include common stock, preferred stock, debt, convertible debt, non-convertible debt, warrants, options and other rights. Preferably, the security sold in one aspect of the invention is in the form of newly issued shares of equity (e.g., common stock). Debt securities include, without limitation, high-grade bonds, high-yield bonds, emerging market bonds, agency bonds, municipal bonds, and European fixed-income products, including Eurobonds, European high-yield bonds, and European-dominated emerging markets bonds. Moreover, the invention can be adapted for use with futures and convertible debt securities.

Investment projects further include illiquid investments and restricted securities, without limitation, such as, for example, accounts receivable, liens, defaulted debt, distressed real estate, derivatives, hedge funds, managed futures, venture capital, private equity, leveraged buyouts, real estate partnerships, private placements, private equity investments, non-publicly traded REITs, commercial real estate, limited partnerships, distressed credit, bankruptcy claims, over-the-counter derivatives, whole loan pools, auction rate securities and collateralized debt obligations.

Investment projects include primary and secondary securities, financial products and assets. A primary security of investment project represents the first sale of a security or an asset that is the subject of a investment project. The sale of the security transfers ownership of the security from, e.g., a company selling an asset for capital, to an investor. The primary issue of a security may be facilitated or handled by any of an intermediary, custodian or broker (facilitator).

A secondary market is an exchange or market, regulated or unregulated, on which securities and/or interests in investment projects are transferred between unrelated parties for good and valuable consideration, most often cash. A secondary market provides a market on which an owner of a security exchanges the security for cash.

The invention includes a method, system, marketplace, financial product and computer program product for matching one or more investors with one or more investment projects. The inventions includes matching at least one investor with at least one investment project by comparing confidential investor characteristics with confidential investment project characteristics. The matching is preferably carried out anonymously such that neither the investor nor the investment project initially knows identity of the other party. After an initial match between investor and investment project has been made, the identity of at least the first investment project is disclosed to the investor. If at least the investor is interested in proceeding the identity of the investor may be made know to the investment project. Subsequently a mediator works to obtain an executed agreement of non-disclosure between the first investor and the first investment project. The non-disclosure agreement acts to obligate the parties to protect the confidential information from the other party. After execution of the non-disclosure agreement further confidential information is exchanged between the investment project and the first investor. The parties can then decide whether it is in their respective best interests to complete a transaction and negotiate the details in furtherance thereof. Preferably the invention is carried out at least partially over a communications network with a computer (e.g., one or more steps are carried out electronically)

In embodiments the invention may be carried out with human assistance, without human assistance and/or at least partially with human assistance. Human assistance may be in the form of direct human contact between a representative for an investment project and one or more of a mediator, intermediary, broker, legal representative of/for an investor. Human assistance may also be in the form of direct human contact between an investor and an investment project and/or representative for either the investor or the investment project. Human assistance can also include direct human contact between a representative for an investor and a representative for an investment project.

Human assistance includes contact between individuals representing any party involved in the transfer or sale of one or more investment projects that occurs through means and/or devices such as oral communications, electronic communications, written communications, and the like. Direct human assistance occurs with or without the use of an intermediary and may occur in a face-to-face manner, e.g., orally, and/or by written communication, and/or real time electronic communication (e.g., telephone email and the like). Direct communication is addressed to the parties involved in the communication.

Any step included in the invention may be carried out by an individual and not through an automated computer-based technique using, for example, human assistance. For example, in an embodiment of the invention an individual may amend documents (e.g., a non-disclosure agreement) to tailor the documents directly to the needs of one or both of the parties involved in a transaction. The individual making such amendments to a document may represent any party including the investment project, the mediator and/or the investor.

In one embodiment an individual directly matches an investment project with an investor as a form of human assistance. This aspect of human assistance may be computer assisted. For example, a computer may first provide a preliminary match of an investment project with one or more investors. An individual may later make a particular selection of one or more investors from the group of investors identified by the computer-based device and place such investors in contact with the investment project or inform the investors that a particular investment project is seeking investors.

A transaction between an investment project and an investor may include a plurality of specific tasks that are either computer automated or carried out by one or more individuals or groups. Such steps include assembling a working group list of investment projects and investors. Assembling a list includes identifying one or more investment projects according to one or more criteria. The investment projects may conform to criteria identifying a particular family of investment projects by type, such as equity investments, debt investments and/or illiquid investments such as accounts receivables. Investment projects may also be identified or assembled according to relative size, for example, investment projects requiring up to $1 million, investment projects requiring from $1 million to $2 million, investment projects seeking $2 million to $5 million. Investment projects may likewise be categorized in terms of industry (e.g., by SIC code) or by describing the group or individual offering the investment project in return for investment (e.g., charities, retirement funds, pensions funds etc.). For example, investment projects may be assembled by industry groups such as microelectronics, biochemistry, real estate and the like. Investment projects may be categorized according to the group or individual organizing or mediating the legal aspects of the investment project such as an investment bank, an investment company, an institutional investor and the like.

The working group list preferably includes both investment projects and investors. In addition it is preferable that a mediator is included on the working group list. The working group list does not need to include each individual or employee of the investment project, investor or mediator. In preferable embodiments of the invention, the working group list is categorized by investment project, investor and mediator, each of which is further categorized to the level of functionality or particular individual included on the list. For example, particular individuals may be identified by name or function, e.g., controller, chief financial officer, chief technical officer and the like. The working group list may also be assembled according to individuals or groups representing any of the investment projects, investors or mediator. Such individuals representing any of the aforementioned parties may be attorneys or other parties acting on behalf of the investment project, investor or mediator. The attorneys or legal representatives may be the same as those attorneys who prepare and/or amend any documents necessary to carry out the transaction.

Assembly of the working group list, in one embodiment of the invention, is an important function of the invention. The working group list identifies those individuals, parties or groups who may later be given permission, clearance and/or authority to view proprietary or private information from any of the parties involved in an investment transaction.

Assembling the working group list may be carried out before any private or proprietary information is exchanged between parties. Assembly of the working group list may also be considered a work in progress during the invention. The working group list may be expanded, amended or shortened as a transaction is developed and concluded. An initial working group list may include only those individuals or groups of parties necessary to confirm that further contact and exchange of information between groups is warranted. The working group list may therefore have degrees and stages identifying particular individuals, groups or functionalities of the parties who are entitled to view and/or exchange proprietary or private information between the parties.

Embodiments of the invention include one or steps or stages in which due diligence information is gathered and, optionally, verified. Due diligence information includes both marketing and technical information that is considered private or proprietary by any of the parties and/or which may be publicly available. The gathering of due diligence information is preferably carried out by the mediator of the invention or a third party subject to a nondisclosure agreement with any of the mediator, investment project or investor.

Due diligence information is gathered by, for example, requesting a submission of the same from the parties and may be gathered in one or more stages. Initial stages may collect due diligence information that describes only, for example, the financial performance and projected financial performance of a particular investment project. Other stages of due diligence information may include, for example, customer lists, marketing plans, profit and loss statements, warranties and declarations of individuals involved in the transaction. In a preferable embodiment of the invention the mediator gathers due diligence information from an investment project prior to the identification of a particular investor or group of investors. The due diligence information may be gathered such that a template of information is completed either by the investment project or by an individual obtaining information from the investment project to complete a due diligence template the data of which is subsequently saved in electronic form on for example electronic storage media such as a hard drive or server.

Due diligence information may also be collected from investors. Due diligence information may include data identifying the particular parties of an investor or investor group. Other private or proprietary information may include the investment history of an investor or investment group, the investment thresholds or target returns for an investment group, the nationality of an investor group or any characteristic which may identify with particularity or generality the characteristics of the investor.

The due diligence may produce a database of information from one or more of the investment project or investor. The thus-gathered due diligence information may be quarantined by the mediator, may be held only by the investment project or investor, and/or may be held by a third party independent of the mediator or any other group involved in the transaction. In a preferable embodiment of the invention, the due diligence gathering provides a database of information that is held only by the investment project or the investor.

Embodiments of the invention include one or steps or stages in which the investors are reviewed, screened and/or vetted. In one embodiment of the invention a mediator reviews a database of potential investors to identify one or more investors having a high probability of interest in one or more investment projects. The database of potential investors may be proprietary information held only by the mediator or by one or more third parties independent from or controlled by the mediator. In one embodiment the database is owned by a third party and is leased to the mediator. The database may include those investors who were previously vetted or have a proven history of access to investment funds and/or who have previously committed investment funds to other investment projects with the mediator. Alternately, the potential investors who are reviewed as a source of funds for an investment project may be named in database that is publicly available or privately available for hire. Potential investors may include individual investors, institutional investors, investment banks and the like.

The review of a database of potential investors may be carried out by comparing the characteristics of the investors with the characteristics of one or more particular investment projects or model projects. For example, an investment project may wish to have only a single large investor. Review of a database of potential investors, e.g., by a mediator, may be carried out by matching the total investment desired by the investment project against the investment resources or investment target information known or estimated for the investors in the database of potential investors.

The review may be carried out mathematically. In one aspect the review is a matching routine which searches particular criteria between investment projects and investors to identify matches. In another embodiment of the invention potential investors are identified by probability. Probability may be determined by comparing a probability score derived from the characteristics of the potential investor relative to the characteristics of the investment project. For example, the investment project may provide estimates of return and/or estimates of risk and/or payback period that vary over wide ranges. The database of potential investors may likewise characterize investors with only limited degrees of precision. For example, a potential investor may be identified as an individual or group desiring to provide funds for investments that have a return on investment within a certain range and/or from developers whose investment projects have a prior history of success. Exact matches may not be determinable for each investment project. Nonetheless investment projects and investors converge with overlapping, touching or exclusive ranges of characteristics.

By scoring any of the investment project and the potential investor according to scales and/or weighting criteria, matches between investment projects and investors can initially be determined. Such matches may later be verified by submitting generalized or generic descriptions of the investment project to the potential investor as a pre-screening to determine a level of interest.

In embodiments the invention includes informing identifying one or more compliance officers from the investment project and/or one or more investors that an initial match has been identified matches between investment projects and investors. Compliance officers are those individuals representing an investment project or an investor who serve the function of reviewing a transaction (e.g., the proposed transaction identified as an initial match) to determine compliance with federal, state or local regulatory requirements. For example, a compliance officer may be an attorney who reviews a transaction to determine whether the transaction will be in accordance with antitrust laws. Compliance officers may likewise review a transaction to determine whether conflicts may arise by exchange of proprietary information between parties to the proposed transaction. Compliance officers may have responsibilities throughout the transaction. The inclusion of compliance office review serves to lessen the likelihood of post transaction litigation.

Preferably compliance officers for both the investment project and investor provide explicit notices of acceptability for a transaction in stages. Compliance officers may, for example, carry out an initial compliance check giving clearance for one or both parties to move forward with the exchange of a first level of proprietary or private information. During later stages of a transaction one or more compliance officers may provide further permission and/or notices of acceptability to release additional and/or more detailed private or proprietary information to the other party or a mediator acting on behalf of either party.

In embodiments the invention includes compliance officer approval to exchange confidential information. After initial reviews one or more compliance officers may approve the initial stage of the transaction. Approval of initial stages may represent a first instance in which proprietary or private information is exchanged between parties. Exchange of such information may require that those individuals who obtain knowledge or familiarity with private and/or proprietary information from another party (e.g., contaminated individuals) be quarantined from advising in certain other transactions. A contaminated individual or party may be barred from future negotiations or business with the affected party.

Approval at the initial stage of upon exchange of a first level of confidential information provides the investor and/or investment project to determine whether any conflicts or competitive issues affects the feasibility of an agreement between the parties. The invention thus provides one or both of the investor or investment project an opportunity to undertake a preliminary analysis of a transaction partner before exchanging substantial confidential information and/or a second level or stage of confidential information.

The date and time at which the compliance officers approve exchange of confidential information is noted, preferably in an electronic database. Likewise, the particular times and dates upon which any individual representing any party in a transaction is exposed to private or proprietary information becomes recorded in one embodiment of the invention. The particular date and time that an individual or group is exposed to or learns of private and proprietary information serves to characterize the group in later or new negotiations.

In embodiments the invention includes preparing a log and/or a database of individuals and parties having access to confidential, private or proprietary information. Any individual who is identified as compliant, e.g., approved for exposure to private, confidential and/or proprietary information, by a compliance officer is identified by name or function in a database of information maintained by the mediator or a third party that may be independent from the mediator.

In embodiments the invention includes exchange of documents and proprietary information between investment project and investors. The individuals and/or employee functions identified and logged as individuals and/or functionalities who may be given access and knowledge of other parties' private and proprietary information are given information describing financial projects or investors, e.g., compliant individuals are exposed to the private, confidential and/or proprietary information from the other parties to a transaction.

Such private and/or proprietary information is preferably dispensed and distributed only on a “need to know” basis. For example, an accountant working on behalf of an investor may be given information that is particular to the accounts receivable condition of an investment project. The accountant may solely be responsible for determining whether the accounts receivables are in fact collectable. The accountant thus charged with examining accounts receivable may be segregated or quarantined from information unrelated to accounts receivable. For example, such an individual may be quarantined from information describing financial particulars of the investment project such as expected rate of return and/or other parties directly or indirectly benefitting therefrom. An individual in the function of accountant may likewise be excluded from exposure to information regarding technical details of the investment project.

In embodiments the invention includes preparing draft documents. Upon review of information describing the investment project and/or investor, one or more individuals or functionalities from parties involved in the transaction may begin negotiations describing details of the transactions between parties. Such preparation may include drafting legal documents such as contracts describing the responsibilities of the party and/or the particular financial conditions of the transaction.

In a preferable embodiment of the invention draft documents are prepared from a database of template documents. The template documents may be essentially complete other than particular information describing the investment project and investors of a particular transaction.

In embodiments the invention includes exchanging draft documents between parties. Exchange of draft documents may occur directly between parties or may occur through a mediator. In a preferable embodiment of the invention a first group of draft documents is provided to the investor by the investment project. The first documents describe the financial conditions of the investment project and/or conditions of a financial transaction associated with the investment project and may, optionally, include private or proprietary information. Preferably the initial exchange of documents is sufficient for the investor to reach a determination whether investment in the particular financial project is appropriate for investment or appropriate for further review and the exchange of further private, proprietary or confidential information.

In embodiments the invention includes investor review and comment of the draft documents and/or conditions of the investment project. After reviewing documents received from the investment project the investor may comment and request changes to the draft documents or may request changes to the transaction. Preferably the investor makes changes to the draft document based on a template of pre-drafted changes.

In embodiments the invention includes developing agreed-upon documents between the investment project and the investor. After initial exchange of documents those individuals and/or groups of any of the investment project, mediator and investor who are identified and/or logged as acceptable parties for viewing and/or private, proprietary and/or confidential information from the other party develop agreed upon documents which define the terms of a transaction. Such terms may include pricing, closing date and any of the terms which may be a function of the transaction.

In embodiments the invention includes the distribution of documents and exchange of assets after agreement. After terms have been agreed by all parties, signed documents are distributed to each participating party and assets are exchanged. For example, an investment project may deliver those documents necessary for the investor to gain access and control of certain assets and/or securities and/or rights in exchange for, preferably, cash provided by the investor.

In embodiments the invention includes a press release. According to agreement with the parties one or more press releases may be issued during negotiations, prior to negotiations or upon completion of a transaction. The press release may identify one or more parties and/or one or more conditions of the transaction.

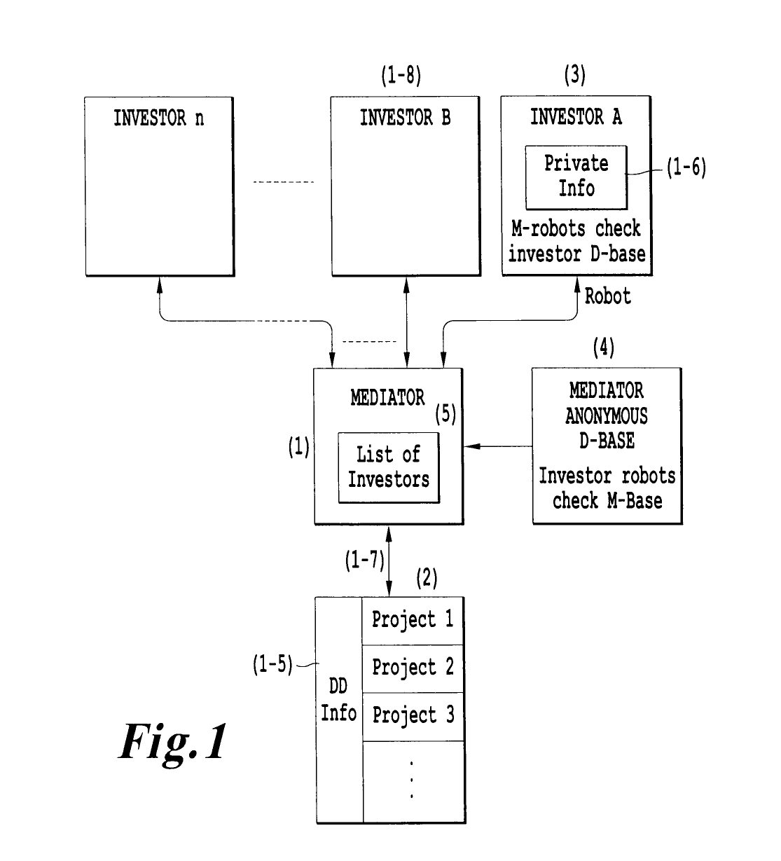

An embodiment of the invention is shown in FIG. 1. The mediator (1-1) is a party acting between one or more investment projects (1-2) and one or more investors (A) (1-3). The mediator may maintain in the mediator's possession and/or control an anonymous database of investors (1-4). The anonymous database may identify one or more investors according to particular characteristics of which the probability and/or degree of interest of a particular investor in a particular investment project may be determined or estimated. The mediator's anonymous database (1-4) may be in electronic form saved on electronic media such as a hard drive or server. Alternately, or in addition, the mediator may be in possession or control of the list of investors (1-5) identifying one or more investors or groups of investors who may be willing or interested in participating in investment projects. The list of investors may include private and/or proprietary information which is critical to identifying particular investors having goals or targets that are compatible with offered investment projects.

The investment project or group of investment projects (1-2) is segregated from direct communication and inspection by the investor or group of investors (1-3) by a virtual wall. The virtual wall exists so that the investment projects do not have particular knowledge of the investors. The mediator (1-4) acts as a bridge, portal or gateway between investment projects and investors.

Preferably, each investment project includes a database of private or proprietary information (1-5). In a preferable embodiment of the invention the proprietary and/or private information of the investment project remains in possession and control of the individual investment project. Likewise the investors (1-3) may have a database of private information which, preferably, remains in the possession and control of the investors (1-6). In this regard possession and control means that the proprietary information of the investment project is physically and electronically under the control of the investment project. In one embodiment the database is stored electronically only on electronic storage media held by the investment project. Likewise, the private and/or proprietary information held by one or more investors is preferably in the investor's direct possession and control such as saved on electronic media that is physically in the possession of the investor.

A communications network (1-7) such as the Internet or a private communications network (e., a VPN, intranet, extranet etc.) interconnects the investment project, the mediator and the investor. Nonetheless, the proprietary database(s) of the investment project and the investor(s) are preferably separated from one another by firewalls (1-8) designed to block unauthorized access while permitting authorized communications (e.g., any one or more of a packet filter, an application gateway, a circuit-level gateway, and a proxy server) and/or other security techniques which prohibit access and/or analysis of the private and/or proprietary information under only certain circumstances.

In one embodiment of the invention the mediator discharges an electronic query to one or more of the investment project or investor database. The electronic query is a series of questions which are compared with the private and/or proprietary information held by the investment project or the investor. The questions are matched against the database and electronically produce an answer packet. The answer packet is dispatched from, for example, the investor server on which the private and/or proprietary information is saved, and sent to the mediator. An electronic query is likewise dispatched from the mediator to the investment project.

Comparison of answers from both investment project and investor permits matching of investment projects and investors. The answer packet received by the mediator from the investment project or investor is subjected to an electronic analysis and/or algorithm to determine the level of interest and/or probability of match between investment project and investor. Such algorithms may weight particular factors such as the investment project's desire for investment with the investor's supply of funds, the projected rate of return of the investment project with the threshold rate of return required by the investor, etc.

By segregating both physically and electronically the proprietary data of both the investment project and investor, the mediator may determine a preliminary match between investment project(s) and investor(s). The at least preliminary match constitutes a first step of the invention which, if answered in the affirmative (i.e., at least one of both an investment project and an investor are matched and agree to preliminary disclosure) may open the door to further negotiations between the investment project and the investor. Alternately, comparison of the answer packet from investment project and investor may serve as a screen to eliminate certain investment projects from an investor's target portfolio and/or to eliminate certain investors from a pool of potential investors targeted by certain investment projects.

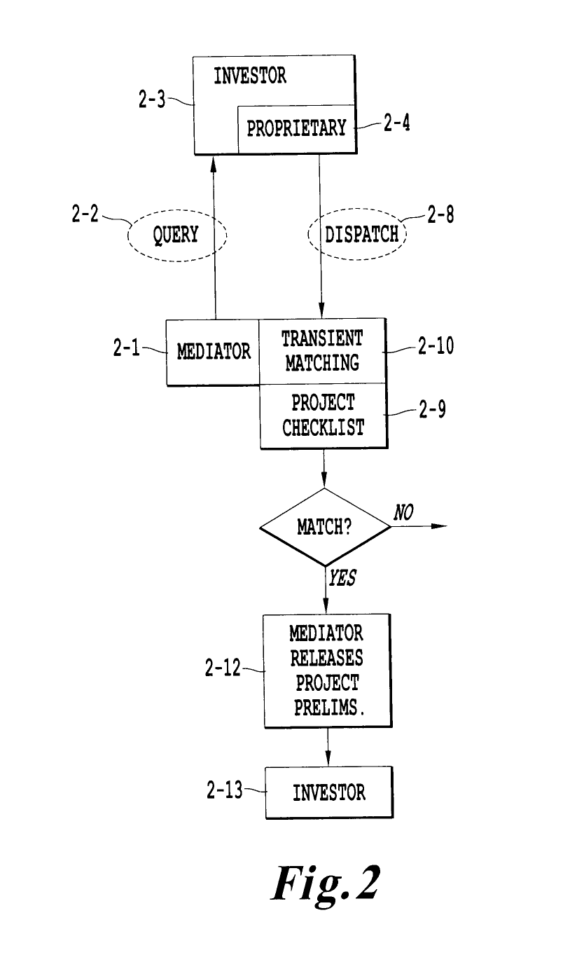

FIG. 2 depicts an embodiment of the invention in which a query is dispatched from a mediator (2-1) to one or more investors (2-3). The query dispatch (2-2) includes software means that determine whether an investor is an acceptable match for an investment project. In one embodiment, the query is an information packet sent over a communications network such as the worldwide web from the mediator for receipt by the investor (2-3) on a server. Once received by a server at the investor, the query is given access to a proprietary database or quarantined database (2-4).

The system of the invention also provides for the investment project and/or investor to selectively allow access to private, confidential and/or proprietary information by assigning permission for certain parties to view such information. The system may also include features for enabling parties to identify contacts of their respective parties.

The query includes a series of questions presented in generic form. For example, the query may include a question or inquiry to determine the type of investment which may be of interest to any particular investor. The query may include a question such as “Is the investor interested in investment projects relating to an industry having the SIC code XXXX?”. The query may approach the investor's proprietary database residing on a server in the possession and control of the investor to determine whether the question in the mediator's query provides an affirmative or negative response. In a preferred embodiment of the invention, each question of the mediator's query has only a binary response profile, e.g., affirmative or negative. In another embodiment of the invention, the question may alternately be answered a “no response”.

The questions of the mediator's query are designed so that a binary response or no response is provided. A benefit of formatting the questions to provide only binary answers is that the particulars of the investor's investment profile are not released from the investor's possession and control.

The questions of the mediator's query (e.g., the questions which are used as a basis for determining a match between an investment project and an investor) can determine binary responses for any of the criteria judged by the mediator or investor as necessary for finding a match between investment projects and investors. Such questions may probe the investor's desirable rate of return, desirable subject matter for investment, and/or any other characteristic or criterion which the investor or mediator deems appropriate for finding a match to desirable investment projects. Preferably such questions are queried against a database template which has standardized information or descriptive information which can be used as a basis for answering the query.

In a preferred embodiment of the invention, each investor queried by a mediator's query has a proprietary database including questions formatted in a standardized template such that a single mediator's query (representing questions relevant to one or more investment projects) can be matched against any number of investor profiles (i.e., proprietary and/or private databases) to find acceptable matches between investors and investment projects. In one embodiment of the invention, the mediator electronically transmits a database template to the investor who subsequently completes the database template and saves the resultant information on a server that is connected to a communications network which also connects to the mediator and/or the investment project. The proprietary database is formatted such that the mediator's query is first challenged with encryption, a password and/or firewall to permit access and matching against only those queries and/or only those mediators which the investor particularly approves having access to the proprietary and/or private database.

The mediator's query can be programmed with access policies that permit or deny access of the mediator's query to the investor's database. Access policies may function in real-time such that access of a mediator's database can be refused at any time an investor wishes to deny access to a private or proprietary database. Access policies which are controlled by investors permit the investor a greater level of security and privacy and thus represent a preferable embodiment of the invention.

It is further preferable that the mediator's queries are dispatched over the communications network to only those investors which have uniquely or independently registered with or provided information to the mediator. The query is thus unlike a web crawler because it preferably queries only those proprietary and private databases for which known addresses are available. Directing the query dispatch to only known addresses also avoids release of the mediator's proprietary information to others in connection with the communications network. Preferably, the mediator's query is directed only to those investors wishing to participate in investment projects for which the mediator has access or functions in a representative capacity.

After matching the mediator's query against the investor's proprietary or private database and electronically receiving and/or generating answers, the server at the investor releases a dispatch (2-8) to return binary answers and/or “no response” answers to the mediator. The investor's dispatch preferably only includes sufficient information to address the dispatch for return to the mediator's server and the binary responses coded to the mediator's questions. Once received by the mediator, the investor's dispatch can be reviewed automatically or by human assistance to determine whether a match exists with respect to any a particular investment project. It is preferred that mediator queries are specific to investment projects. Where a particular investment project may have multiple queries, it is preferable that each query is specific to only a single investment project.

It is not necessary for every response of the investor's dispatch to be affirmative in order for a match to be identified between an investor and an investment project. The responses of an investor's dispatch can be prioritized or weighted in order to determine a probability of a match. Such prioritizing and weighting can be carried out according to a project checklist (2-9) which is part of a transient matching systems (2-10). Defining probabilities helps allow the invention to match investors and investment projects that deviate from the ideal in one or more aspects, but nonetheless, are sufficiently compelling to generate interest for investment or investors.

The probability targets may be established by the mediator to determine whether further contact and/or analysis of an investment project/investor match is warranted. If an investor dispatch signals that a particular investment project may meet the requirements for an investor, the mediator may request release of preliminary information from the investment project to the investor or from the investor to the investment project. Alternately, the mediator may contact one or both of the investor and the investment project to request release of preliminary information, or to otherwise determine whether further inquiry is appropriate.

Upon determining that a particular match is worthy of further inquiry (see (2-12) which shows a match routine), the mediator may automate the release of a preliminary description of the investment project that may be described in terms of proprietary or private information of a first level. The first level of proprietary or private information that describes, in preliminary terms, the investment project may vary depending on the investment project and may include such descriptions or characterizations as industry type, amount of funds requested, expected rate of return, and the like. Similar, preliminary, proprietary, confidential or private information may be released by the mediator or directly from the investor such that it is viewable by the investment project. The investment project may carry out a preliminary screen to check for conflicts.

Preliminary, proprietary, confidential or private information may be released (2-12) with or without a nondisclosure agreement. It is preferable that the first release of preliminary information which may optionally include private or proprietary information, is released without a nondisclosure agreement signed by either the investor or the investment project. It is further preferable that the parties involved, i.e., the investment project, the mediator, and the investor agree to rules of conduct that binds each party to certain ethical standards such that the public release of first level preliminary information is prohibited. Release of the mediator's conclusion regarding matching to a particular investment project may occur automatically (2-13) or be human-assisted.

If after review of preliminary proprietary information by the investor and the investment project generates further affirmative responses signaling that both the investor and the investment project are willing to carry forward with further analysis, a formal nondisclosure agreement between parties may be executed. In a preferable embodiment of the invention, the nondisclosure agreement is a template document prepared in advance by the mediator and available as a database of template documents. Upon execution of the template nondisclosure agreement by both parties, further proprietary and/or private information may be released from the investment project to the investor, or from the investor to the investment project. Such further information may constitute a second level of preliminary, proprietary, or private information or may constitute and/or comprise an upper level of proprietary information which describes the investor's needs and the investment project's characteristics in detail. In the invention, such high level proprietary and/or private information is not released to any party in the absence of a nondisclosure agreement.

In one aspect, the invention provides a marketplace and environment for posting and transacting confidential deals. As explained herein, transactions between individuals or entities are preferably kept private to protect the interests and privacy of the individuals and entities involved. However, such a need for confidentiality may hamper the ability of investors and investment projects to find one another. Confidential deals are do not publish the details of terms and conditions and/or no public announcement is made. An individual or entity wishing to remain confidential has an increased burden with respect to finding investors to carry out an investment project. The individual or entity cannot simply place an advertisement on an on-line bulletin board because doing so would necessarily contradict the confidential nature of the transaction and the interests of the individual or entity wishing to remain confidential.

The invention provides a marketplace in which both investment projects and investors may remain confidential but still signal interest in one another without any initial disclosure of particular deal terms. Investment projects and investors may be matched according to generalized characteristics and/or criteria. A mediator involved in matching investors and investment projects can function in a confidential manner to match particular investors with particular investment projects such that the identities of the entities remains confidential as do terms of any deal or proposal. The identity of the investment projects, entities, or individuals owning or representing such projects and/or the investors interested in providing cash for participation in an investment project may remain confidential and unknown to the other party throughout an embodiment of the invention up to final agreement of terms and/or execution of documents. In a preferable embodiment of the invention, the identity of the individuals and/or entities involved in a deal remains confidential only up to a preliminary match which functions to permit the mediator to identify investment project and investor to one another.

In one aspect of the invention, documents exchanged between parties and used to announce and/or describe details of a transaction are based upon a library of standardized deal documents. Standardized deal documents are templates which are easily amendable to changes and editing to include particular deal and/or transaction details. The use of standardized deal documents, for example, nondisclosure agreements, provides a level of efficiency to the process of carrying out a transaction that is not possible in conventional deal conditions.

The standardized documents and/or templates used in embodiments of the invention can be modified according to any party's requirements. Modifications to standardized deal documents are agreed to between the parties with or without input or consultation with the mediator. Standardized documents may be similar to forms such as the ISDA master agreement from the International Swap Dealers Association, Inc. Generally accepted terms which are neutral to the parties are spelled out in the contract and form the basis for seeking legal remedies against non-performing participants.

The mediator can function as a web-based or proprietary information portal or provide the service of a web-based or proprietary information portal. For example, in another aspect of the invention, the mediator may maintain and monitor an information portal which provides access to a private or proprietary database. The portal may be in the form of any of an enterprise portal, an Intranet portal, a web portal, and portals network programming API. In embodiments the portal functions as a gateway to unifies and standardize access to the investor and investment project information on an intranet, server, confidential database and/or the Internet. The portal manages the data, software applications, and information of a transaction between one or more investors and one or more investment projects with or without a mediator.

The mediator may maintain databases of proprietary and/or private information describing investors and investment projects on the same or different servers. Access to investor-based or investor-originated may be databases and investment project-based may be by password. The respective databases or database areas are protected such that unpermitted access is not allowed. During the invention, after a mediator has found a preliminary match between an investor and investment project, the mediator may, automatically, provide to the investor a password for access to a quarantined database describing certain details of the investment project. Likewise, subsequently or concurrently, the mediator may provide a password for representatives of the investment project to access a portion of the database describing the particulars of the investor. By accessing quarantined portions of the investor and investment project database on the mediator's server, the parties to a transaction or proposed transaction are able to carry out further inquiries with respect to determining whether a transaction is in the best interests of one or the other party.

In the context of the invention, due diligence describes to the actions taken by the investor, investment project and/or mediator parties participating in a transaction to review the details of the transaction and the parties involved to determine that the transaction and/or contract to be entered as part of the transaction are in the best interests of the respective parties.

Due diligence may be carried out by the parties involved or by representatives of the parties involved. A representative acting on behalf of a party in a transaction has an obligation to disclose information discovered about other parties involved in the transaction or details of the transaction learned during analysis or investigation of the transaction. Due diligence includes analysis of information regarding the finances, legal status, pending litigation, labor, tax, information technology, environmental, marketing and business situation characteristics of a party involved in a transaction or a party having or holding direct interest in another party to a transaction. The due diligence required of a business transaction carried out in accordance with the invention may include analysis of any of the investment strategy of an entity involved in the transaction, historic business performance, prospective business performance, a description of the assets and liabilities of an individual or an entity, a description of risk factors and market development, a description of the value of an asset that is the target of the transaction and the basis for such valuation, and information including, for example, criminal histories and prior litigation of any party involved in a transaction. Preferably, due diligence is carried out by a licensed professional hired or in the employ of a party to a transaction.

In the context of the invention, the mediator is a party or business organization that acts as a go-between for parties at the opposite ends of a business transaction. The mediator may represent and/or be retained by one of the parties of the transaction. The mediator of the invention is not necessarily neutral and is different from a mediator in the context of dispute resolution. The mediator of the invention may have a financial stake in the outcome of a transaction. For example, the mediator of the invention may own assets or a portion of the assets of the investment project and/or may be an investor and/or may act on behalf of an investor entering into a transaction with a investment project identified or matched by the invention.

The mediator preferably provides services, both proprietary and public, to one or both of the parties of a transaction. In one aspect, the intermediary functions merely to identify or match investors with investment projects. The intermediary may be paid for consultation or may receive a commission that is commensurate with the value of the transaction and the intermediary's activities during the transaction.

The sale, transfer and/or exchange of the securities that are the basis of an investment project maybe be traded on an exchange and/or trading systems such as the Bloomberg terminal or other proprietary trading system. Sales and/or transfer between parties can be conducted with the additional services of any of intermediaries, facilitators, custodians and/or brokers. The intermediaries or brokers may provide any kind of transaction aid such as block trading desks, security exchanges, auction forums, and electronic communication networks (ECN). Alternately the parties may use an order matching system for executing sell orders without disclosing to the marketplace the precise details of price, quantity, or type in order to avoid impacting the price in the marketplace.

In other embodiments of the invention the communications network may include one or more database sources which provide financial and marketing information describing the investment project and/or party offering participation in the investment project. The databases may include services such as a video library which includes presentations made by the investment project describing the security and/or asset for sale highlights of the investment project.

The database may likewise include third party content. For example, the database may include analyst reports specific to the investment project an/or information relating to industry specific reports, company specific reports or any type of financial statistical information such as historical averages, price performance and the like. The database, e.g., data room, may be managed by the investment project and/or the mediator or may be managed by a facilitator, custodian or intermediary acting on behalf of the investment project or mediator. In one embodiment the database includes road show presentations which describe aspects of the investment project business and financial goals and targets.

The communications network includes a communications routing connecting the investment project, mediator and/or investor to a market environment that may include public and private primary and secondary markets. The investment project and/or investor may interact with the exchange and/or another party such as a broker, facilitator or custodian, through the communications network. The investment project may use a human to monitor the database and/or monitor the database through a computer-based automated system such as a desktop terminal or a computer or automated device.

Sales of all or portions of the investment project may be initiated and completed using any communications device including electronic display and/or communications devices such as, but not limited to, mobile PDAs, cellular telephones, devices such as Blackberries, special purpose terminals such as Bloomberg terminals and the like.

The representative for the investment project may dispatch an order to complete a transaction on a secondary market using conventional means such as those means which communicated with the exchange over a communications network. In one embodiment a representative for the investment project makes a telephone call to a broker, another representative or facilitator who is in direct communication with the exchange to indicate to the broker etc. that the investment project wishes to make an offer to sell. The representative may also be in direct contact with an exchange, secondary market and/or any intermediary through other electronic communications means such as email, instant messaging, or any other electronic communications means supported by the networks and communications infrastructure described herein.

Electronic communications networks (ECNs) which are computerized trade-matching systems capable of uniting the best bid and offer prices can be used as part of the communications network. For example, ECNs may by-pass broker-dealer commissions as well as exchange fees. An ECN allows its participants such as brokers/dealers, market makers, and buy-side institutions to post bids and offers into a market quote system, such as the NASDAQ system.

The communications network and/or the system of the invention may include one or more servers, also referred to as a trading device which is preferably implemented by the use of one or more general purpose computers, such as, for example, a Sun Microsystems F15k having special purposes instructions, such as, for example, a typical personal computer manufactured by Dell, Gateway, or Hewlett-Packard. The trading device can include a microprocessor which can be any type of processor, such as, for example, any type of general purpose microprocessor or microcontroller, a digital signal processing (DSP) processor, an application-specific integrated circuit (ASIC), a programmable read-only memory (PROM), or the like. The trading device may use its microprocessor to read a computer-readable medium containing software that includes instructions for carrying out one or more of the functions of the trading device.

The trading device can include computer memory, such as, for example, random-access memory (RAM) or any type of computer memory or any other type of electronic storage medium that is located either internally or externally to the trading device, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), a computer-readable medium, or the like. According to exemplary embodiments, the respective RAM can contain, for example, the operating program for either the trading device. As will be appreciated based on the following description, the RAM can, for example, be programmed using conventional techniques known to those having ordinary skill in the art of computer programming. The actual source code or object code for carrying out the steps of, for example, a computer program can be stored in the RAM. The trading device can also include a database. The database can be any type of computer database for storing, maintaining, and allowing access to electronic information stored therein. The trading device preferably resides on a network, such as a local area network (LAN), a wide area network (WAN), a virtual private network (VPN), or the Internet and preferably is connected to the network to enable electronic communications between the trading device and other communications and/or processing equipment over a communications connection, whether locally or remotely, such as, for example, an Ethernet connection, an RS-232 connection, or the like.

The system may have multiple, simultaneous roles in the invention; for example, as an aid for buying or selling securities. The system may access the exchange either through a separate interface or through a web interface provided by the CRA to submit data or through any other aspect of the communications network.

The method, system, financial product, market environment and computer program product of the invention can be implemented in hardware, software or a combination thereof. In one exemplary embodiment, the marketplace is implemented in software or firmware that is stored in a memory or computer readable medium, and that is executed by a suitable instruction execution system. Hardware may include any conventional hardware technology.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor, and the like. Transmission media may include or convey acoustic waves, light waves and electromagnetic emissions, such as those generated during radio frequency (RF) and infrared (IR) data communications, or any other wireless form of communication. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Devices that are in communication with each other need not be in continuous communication with each other, unless expressly specified otherwise. In addition, devices that are in communication with each other may communicate directly or indirectly through one or more intermediaries and/or the communications network. Additionally, a description of an embodiment with several components in communication with each other does not imply that all such components are required. On the contrary a variety of optional components are described to illustrate the wide variety of possible embodiments of the present invention.

Additionally, off-the-shelf software may be used to implement the present invention, such as, but MICROSOFT.NET, MICROSOFT SQL SERVER, or may be designed and programmed using any combination of languages, such as C++, JAVA, JAVA Script, XML, HTML, SQR, or PLSQL. One should understand that interfaces can be executed on a PC or the like, via a web browser over an electronic data network, such as the Internet. Further, interfaces may be executed on wireless client devices, such as PDA's or smart phones.

The invention provides an easy setup via a download from the web, provides security, e.g., using the Secure Sockets Layer (SSL) and dual-key encryption, provides established backup and recovery procedures, and includes third party data services (e.g., information from MoneyLine™ or other financial news services).

A further aspect of the invention includes means and devices for providing computer-implemented trading for investment projects including the step of providing respective computer-generated interfaces for a plurality of dealers, sellers and a plurality of investors. A network enables messages to be exchanged between the investment project interfaces and the investor interfaces. Moreover, the investment project are enabled, e.g., through an mediator, to communicate an inventory of most actively traded securities, and bid and/or offer terms thereof, to the investors via the buyer interfaces. Additionally, an investor can submit an order, via the respective buyer interface, and based on the inventory, for trading a particular one of the most active securities to a dealer. In response to the inquiry, the dealer can communicate a message to the investor indicating whether it accepts or rejects the offer, via its respective dealer interface.

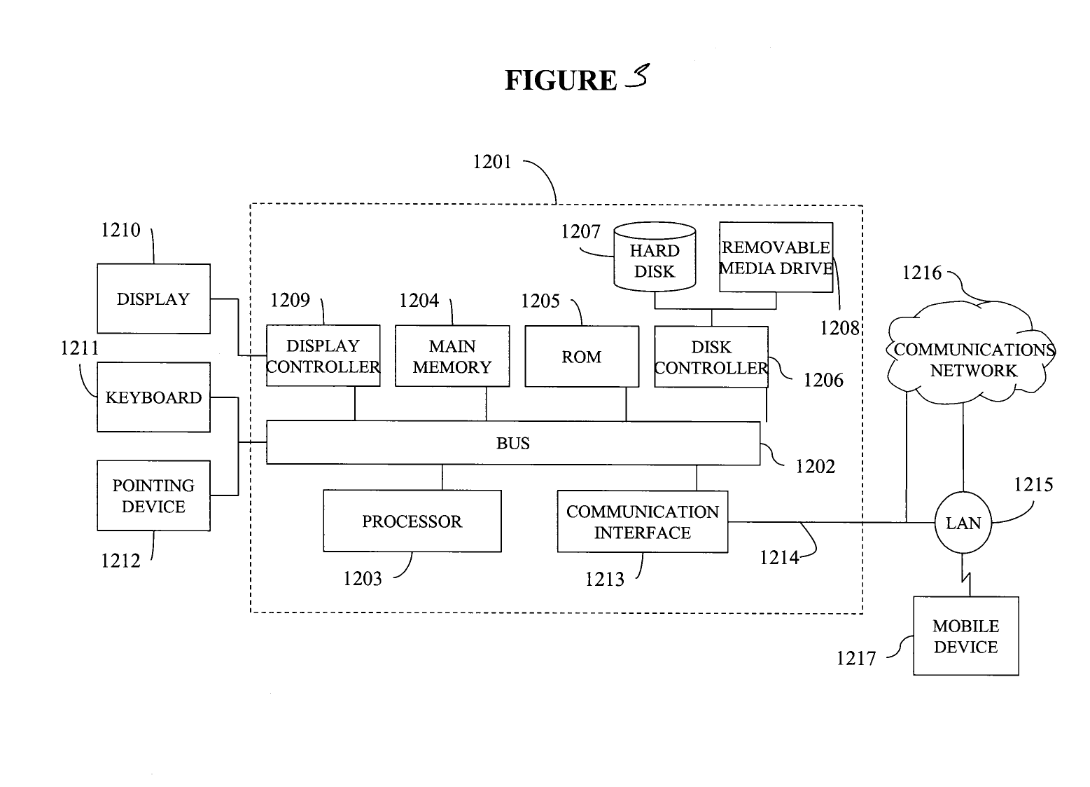

FIG. 3 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A computer readable medium providing instructions to a processor 1203 may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

The continuous offering program agreement of Rodman & Renshaw LLC (the Rodman Continuous Offering) is incorporated herein by reference in its entirety. Under the details of the Rodman Continuous Offering an agent or intermediary may collect a fee for carrying out sales and marketing of securities.

Further embodiments and advantages of aspects that maybe included in the invention are described in the Rodman & Renshaw's “At-The-Market Offering Program” circular, incorporated herein by reference in its entirety.

U.S. patent applications 61/156,354 and 12/713,921 are incorporated herein in their entireties including any attachments, appendixes or materials incorporated by reference.

U.S. patent application Ser. No. ______ titled “Method, System, Market Environment, Computer Program Product and Financial Product for Issuing and Selling a Primary Security on a Secondary Market” filed on Aug. 23, 2010 and naming Michael Vasinkevich as an inventor is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1: A method for matching one or more investors with one or more investment projects over a communications network, comprising:
identifying an initial match comprising a first investor and a first investment project, wherein the initial match is identified by comparing one or more confidential investor characteristics with one or more confidential investment project characteristics;
disclosing the identity of at least the first investment project to the first investor;
obtaining an executed agreement of non-disclosure between the first investor and the first investment project;
disclosing confidential information from the first investment project to the first investor; and
disclosing confidential information from the first investor to the first investment project.

2: The method of claim 1, wherein a mediator identifies the initial match by comparing the confidential investment project characteristics with the confidential investor characteristics without coming into possession of the confidential investor information.

3: The method of claim 1, in which the investment project is a non-registered investment.

4: The method of claim 1, further comprising:
disclosing the identity of the first investor to the first investment project while disclosing the identity of at least the first investment project to the first investor.

5: The method of claim 1, further comprising:
screening a plurality of potential investors to obtain a first set of qualified investors before the identifying.

6: The method of claim 5, wherein the plurality of potential investors is screened by comparing confidential information from each of the investors of the plurality of potential investors against a template of threshold characteristics.

7: The method of claim 1, wherein the identifying is carried out by electronically comparing, with a computer, the confidential investor characteristics with the confidential investment project characteristics; and
wherein the confidential investor characteristics are stored on a first electronic storage medium and the confidential investment project characteristics are stored on a second electronic storage medium.

8: The method of claim 1, wherein the communications network is the interne and the investor and the investment project are matched electronically.

9: The method of claim 1, wherein the first investor is in sole possession of the first investor's confidential information and the first investment project is in sole possession of the first investment project's confidential information; and
a mediator has access to both the first investor's confidential information and the first investment project's confidential information when carrying out the indentifying.

10: A system for matching one or more investors with one or more investment projects over a communications network, comprising:
a communications network connecting one or more investors with a mediator and one or more investment projects;
an electronic storage medium storing a confidential investor database and connected to the communications network;
an electronic storage medium storing a confidential investment project database and connected to the communications network;
a computer configured to identify an initial match comprising a first investor and a first investment project, wherein the computer identifies the initial match by electronically comparing one or more confidential investor characteristics with one or more confidential investment project characteristics;
wherein the computer is further configured to disclose the identity of at least the first investment project to the first investor over the communications network; and
wherein the computer is further configured to disclose the confidential investment project information to the first investor; and the confidential investor information to the first investment project.
